(19) United States
(12) Patent Application Publication
(10) Pub. No.: US 2011/0064582 A1
(43) Pub. Date: Mar. 17, 2011

(54) WIND TURBINE BLADE WITH HIGH-LIFT DEVICES

(76) Inventors: Ignacio Romero Sanz, Madrid (ES); Mario Jimenez De Lago, Madrid (ES)

(21) Appl. No.: 12/994,290

(22) PCT Filed: May 28, 2009
(86) PCT No.: PCT/ES2009/070191

§ 371 Date: Nov. 23, 2010

(30) Foreign Application Priority Data
May 30, 2008 (ES) P200801632

(51) Int. Cl. F03D 1/06

(52) U.S. Cl. 416/223 R

(57) ABSTRACT

Wind turbine blade with high-lift devices in the leading edge and/or trailing edge (the latter has a relative thickness) in the root area, so that aerodynamic performance is improved and therefore the amount of energy extracted from the wind compared to traditional blades with cylindrical or oval roots.

### FIELD OF THE INVENTION

The aim of the present invention patent is a wind turbine blade with high-lift devices in the blade's root area, where there are two types of these elements: high-lift devices on the leading edge area and on the trailing edge area, so that said blade is aerodynamically optimized in its whole geometry to increase the wind turbine's energy production.

### BACKGROUND OF THE INVENTION

Traditional wind turbine blades are joined to the hub in a cylindrical area known as the root, with a characteristic length of usually several meters. For most wind turbines, the function of this area is typically structural and does not significantly contribute to the wind turbine's production, as it is not aerodynamically optimized.

In the current state of the art, detachable elements in the root area, are described to improve the blade's performance. However, they are characterized by having a sharp trailing edge and a very large chord length on the joint with the root.

Thus for example, we have document WO 2007/131937 that describes a blade for a wind-power generator with a detachable element on the trailing edge detachable from the blade itself.

### DESCRIPTION OF THE INVENTION

To solve the above mentioned problem mentioned, the wind turbine blade with a high-lift device is presented, object of the present patent of invention. Said high-lift devices are of two different types, according to their position and use in the blade:

(i) High-lift device of the wind turbine trailing edge area;

(ii) High-lift device of the wind turbine leading edge area;

The high-lift device of the trailing edge is a fixed part, and not mobile like in other aerodynamic trailing edge devices related in the state of the art. The trailing edge of this element is thicker than known trailing edges, obtaining a bigger lift coefficient, which at the same time allows to make the detachable element with less total length (less chord). In other words, a shorter length or chord is obtained for the same lift, with greater trailing edge relative thickness. The device also allows to make a blade with less torsion, owing to having a greater stall angle in losses at high angles of attack. This high-lift device can be part of a one-piece blade and not only as an additional or detachable element.

The leading edge's high-lift device is selected amongst:
(i) a first leading edge high-lift device, slightly curved adapted to the blade root without inflection points on its outer surface;
(ii) a second leading edge high-lift device, with a smaller contact surface with the blade root and an inflection point on its outer surface, on the bottom, improving its operating performance;
(iii) a third leading edge high-lift device, with a pronounced outer profile, without inflection points on the surface and a contact area with the bottom root of the first and second devices' inflection points;
(iv) a fourth leading edge high-lift device, with a minimum contact area with the root, which at the same time creates a very pronounced inflection point on the outer surface of this fourth element, increasing the maximum lift coefficient;

The following technical advantages are obtained with the combined use of the two configurations (trailing edge and leading edge):

The wind turbine produces more energy, on improving the blades' aerodynamic coefficient.

Improved performance is obtained at lower ambient wind speeds, as the wind incidence angle has been improved.

The already installed blades can be used, and their production and transport is also improved and made easier.

### BRIEF DESCRIPTION OF THE FIGURES

A brief description of a series of illustrations is provided below in order to better understand the invention. These illustrations are expressly listed with an embodiment of the present invention and are presented as an illustrative, but not restrictive, example of the same.

FIG. 1 is a ground plan of a wind turbine blade with incorporated high-lift devices, as described in the present invention.

FIG. 2 is a transversal section of the wind turbine blade with the first high-lift device of the leading edge installed.

FIG. 3 is a transversal section of the wind turbine blade with the second high-lift device of the leading edge installed.

FIG. 4 is a transversal section of the wind turbine blade with the third high-lift device of the leading edge installed.

FIG. 5 is a transversal section of the wind turbine blade with the fourth high-lift device of the leading edge installed.

FIG. 6 is a profile view of a wind turbine with installed high-lift devices, according to the present invention.

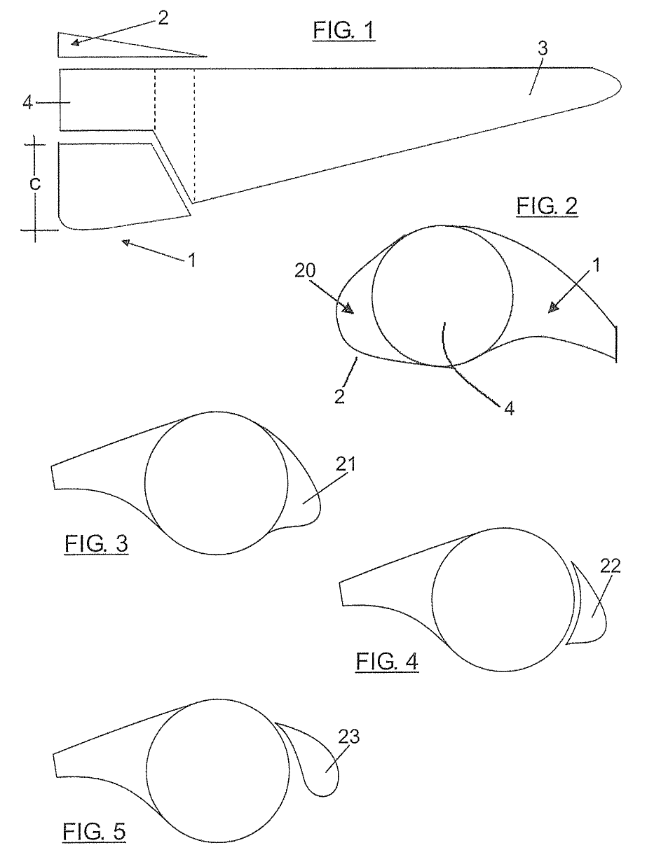

### PREFERRED EMBODIMENT OF THE INVENTION

As can be observed in the attached figures, the wind turbine blade with high-lift devices comprises, at least, a trailing edge high-lift device (1) with a blunt end and chord (C) length of 5% to 30% less than a conventional profile for the same lift coefficient; and as the joint area radius is related to the blade's (3) root (4) radius, and to the thickness of this trailing edge high-lift device (1).

The first trailing edge high-lift device (1) can be detachable or integrated in a one-piece blade.

The leading edge's high-lift device (2) is selected amongst:
(i) a first leading edge high-lift device (20), slightly curved adapted to the blade (3) root (4) without inflection points on its outer surface;
(ii) a second leading edge high-lift device (21), with a smaller contact surface with the blade (3) root (4) and an inflection point on its outer surface, on the bottom;
(iii) a third leading edge high-lift device (22), with a pronounced outer profile, that maintains the clearance between it and the root so than a certain amount of air flow can pass between the intrados and extrados of the profile to energize the profile extrados' boundary layer and improve aerodynamic performance, where this third element (22) can also be mobile (rotary with respect to the center of the cylinder and known in aerodynamics as “slot”) so that it is better adapted to operating conditions set by the ambient flow with the modification of CL and αₛₜₐₗₗ
(iv) a fourth leading edge high-lift device (23), with a minimum contact area with the root (4), which at the same time favours a very pronounced inflection point in the outer surface of this fourth element (23), where, additionally, this fourth leading edge high-lift device (23) or slot, can be mobile (rotary, idem), so that the C_{L} and α_{STALL} ratio is optimized.

In the design of high-lift devices coupled to the wind turbine blade, both on the leading edge and trailing edge, as well as taking into account optimising the ration between C_{L} lift coefficient and the α_{STALL} angle of attack, a safety distance between the geometrical limits of the detachments and the machine itself should be taken into account.

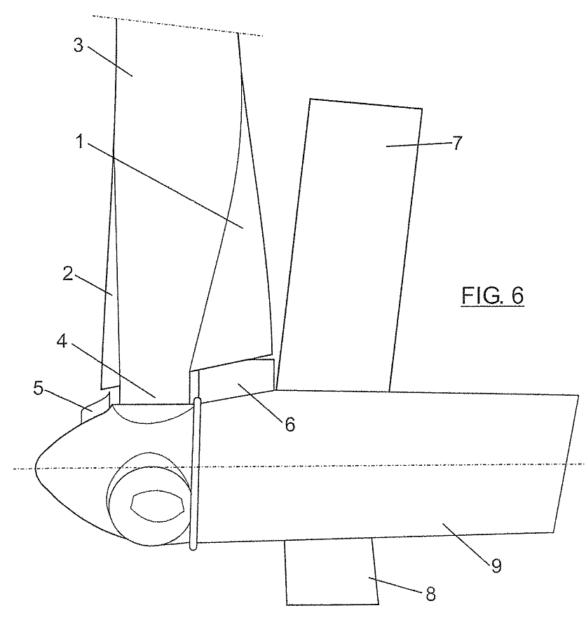

FIG. 6 shows the embodiment of a complete wind turbine, with the tower (8), nacelle (9) and blade (3) and where the installation of these high-lift detachments is specifically shown on a wind turbine blade in which the safety distance of the different devices are graphically indicated: safety distance from the hub (5), safety distance from the nacelle (6) and safety distance from the tower (7), for a maximum chord length, so that a safety distance of around 300 mm from the nacelle, around 300 mm from the hub and around 400 mm from the tower is obtained.

1. Wind turbine blade with high-lift devices characterized by having at least
a leading edge high-lift device (2), integrated in the blade root, with relative movement between the leading edge's detachable element and the blade root
a trailing edge high-lift device (1) integrated in the blade root giving continuity to the blade surface in a chord (C) length and with a blunt edge.

2. Wind turbine blade with high-lift devices from claim 1 characterized by the leading edge high-lift device (2) being one selected amongst:
(i) a first leading edge high-lift device (20), slightly curved adapted to the blade (3) root (4) without inflection points on its outer surface;
(ii) a second leading edge high-lift device (21), with a smaller contact surface with the blade (3) root (4) and an inflection point on its outer surface, on the bottom;
(iii) a third leading edge high-lift device (22), with a pronounced outer profile, without inflection points on the surface and a contact area with the bottom root of the of the first (20) and second element's (21) inflection points;
(iv) a fourth leading edge high-lift device (23), with a minimum contact area with the root (4), which at the same time creates a very pronounced inflection point on the outer surface of this fourth element (23).

3. Wind turbine blade with high-lift devices, according to claim 1, characterized by it including, at least, a trailing edge high-lift device (1) with a blunt end and chord (C) length of 5% to 30% less than a conventional profile for the same lift coefficient;

4. Wind turbine blade with high-lift devices from claim 1 characterized by the joint area radius being related with the root (4) of the blade (3), and the thickness of this trailing edge high-lift device (1).
